(19) United States
(12) Patent Application Publication
(10) Pub. No.: US 2025/0204723 A1
(43) Pub. Date: Jun. 26, 2025

(54) DEVICE FOR TRANSPORTING AND USING COOKING EQUIPMENT

(71) Applicant: OUTLAW PRO LTD, Billericay (GB)

(72) Inventor: Stewart Leonard James LAWSON, Billericay (GB)

(73) Assignee: OUTLAW PRO LTD, Billericay (GB)

(21) Appl. No.: 18/440,337

(22) Filed: Feb. 13, 2024

(30) Foreign Application Priority Data
Dec. 20, 2023 (GB) 2319687.6

(51) Int. Cl. A47J 37/07

(52) U.S. Cl. CPC A47J 37/0786; A47J 37/0763

(57) ABSTRACT

A device for transporting and using cooking equipment. The device comprises a container body comprising a base and side walls which defines a receiving portion for storing cooking equipment. The device further comprises at least one tray for supporting cooking equipment, the tray being releasably attachable to a side wall of the container via an at least one attachment means.

### CROSS-REFERENCE TO RELATED APPLICATION

This application claims priority from GB2319687.6, filed on 20 Dec. 2023.

### FIELD OF INVENTION

This invention is a device for transporting and using cooking equipment.

### BACKGROUND TO INVENTION

A user may wish to cook food when outdoors, such as when camping or fishing, and in such cases will wish to transport and use cooking equipment. In certain situations, the conditions may be unfavourable such as when trying to prepare and cook food on wet, muddy, or marshy ground or an uneven surface. For example, when attempting to use a gas stove on wet, muddy, or marshy ground it will be difficult for the user to keep the gas stove clean without the use of a metal tray. However, if the ground is substantially saturated or uneven it can be difficult to keep the tray substantially upright or prevent it from moving.

Also, when attempting to use a gas stove on wet, muddy, or marshy ground it will be difficult for the user to keep the gas stove upright, potentially causing fire damage to local plant life or peat.

Also, when preparing food on trays on the floor it can be difficult to keep the food from being contaminated, or from environmental contamination through spillages of cooking oil, sauces, artificial preservatives and so on especially on wet, muddy, or marshy ground.

Furthermore, the user has the inconvenience of having to transport all of the cooking equipment that they will want to use.

It is an aim of the present invention to overcome these problems and to provide a device for transporting cooking equipment.

### SUMMARY OF INVENTION

According to the present invention there is provided a device for transporting using cooking equipment comprising:
(i) a container body comprising a base and side walls; defining a receiving portion for storing cooking and food preparation equipment; and wherein:
(ii) the device further comprises at least one tray for supporting cooking equipment releasably attachable to a side wall of the container via an at least one attachment means.

The device of the present invention is advantageous in that the user is thus able to securely and releasably attach a tray to the side of a portable container off the ground, thus meaning that they can not only easily transport all of their cooking equipment in one container, but also be provided with an area for preparation of food and/or placement of cooking equipment thus preventing environmental damage and contamination, food contamination, and unclean or damaged cooking equipment.

The container body may comprise a bucket, which will preferably comprise a rectangular base with four side walls, the side walls being substantially planar to receive the tray.

The device may comprise a handle to permit easy transport of the device.

The container body may comprise a lid which may be received on an upper edge of the side walls of the container body.

The device may comprise at least two trays, each of which may be releasably attachable to attachment means disposed on the side walls of the, providing the user with a larger working space. The or each tray may be releasably attachable to the side walls via two attachment means, which will prevent rotation of the tray when attached to the container body.

Further, the at least two trays may be attachable to opposed side walls of the container body, providing the user with easily accessible space to use either side of the container.

At least one side wall of the container body may comprise at least one mounting aperture, preferably comprising at least two mounting apertures where the tray is attachable to two attachment means.

The at least one attachment means may comprise at least one mounting body protruding from a side wall of the container body. The at least one mounting body may comprise a peg, the peg preferably comprising a flange at an end distal to the container body, allowing the user to easily mount the tray on the attachment means.

The at least one mounting body may further comprise a bolt and nut, disposed through at least one mounting aperture disposed in the at least one side wall of the container body, allowing the user to easily mount the tray on the attachment means.

The at least one tray may comprise at least one raised wall, and preferably may comprise a plurality of raised walls, more preferably may comprise raised walls on every periphery of a base surface of the tray. The raised wall or walls allow the user to keep cooking and food preparation equipment safely on the tray while in use, prevent environmental contamination and provides a drip-tray for the cooking equipment.

Further, the at least one raised wall may comprise at least one aperture, preferably comprising at least two apertures, for attachment to the attachment means disposed on the walls of the container. Further still, the aperture may comprise a keyhole shape, to provide the user with a secure means to lock the at least one tray in place and use the device with confidence.

The device may comprise at least one outer tray which may comprise at least one raised side wall, preferably comprising at least two raised side walls, and more preferably comprising raised side walls on every periphery of a base surface of the at least one outer tray. This allows the user to keep cooking and food preparation equipment safely on the at least one outer tray while in use, prevent environmental contamination and provides a drip-tray for the cooking equipment.

Further, the at least one outer tray may be releasably attachable to the tray or trays via at least one outer tray attachment means. This provides the advantage that it provides the user with an increased amount of secure, steady workspace and potentially allows them to use a wider range of cooking equipment simultaneously.

Further, the at least one outer tray may attach to the raised side wall of the tray, preferably the raised side wall distal to the container body. This provides an advantage that it allows the user to use the increased amount of workspace at the same height.

Further still, the at least one outer tray attachment means may comprise a magnet. This provides an advantage that it allows the user to easily attach and release the at least one outer tray and the at least one tray.

Further still, the at least one outer tray attachment means may comprise a peg which may engage with an outer tray attachment aperture on the at least one tray, preferably comprising a keyhole aperture. This provides the user with a secure means to lock the at least one tray and the at least one outer tray in place and use the device with confidence.

Further still, the at least one outer tray attachment means may comprise a nut and bolt which may engage with an outer tray attachment aperture on the tray, preferably comprising a keyhole aperture. This provides the user with a secure means to lock the at least one tray and the at least one outer tray in place and use the device with confidence.

Further, the at least one outer tray may comprise at least two attachment means, further still the at least one outer tray may comprise a plurality of attachment means. This allows the user to safely mount the tray to the container body and prevent rotation of the at least one tray while in use.

The device may comprise at least two outer trays. Further, the at least two outer trays may attach to the at least two trays attached to the container body. This provides an advantage that it allows the user to use an increased amount of secure, steady workspace and potentially use a wider range of cooking equipment simultaneously.

The device may comprise at least one extendable leg which may optionally support the at least one tray, and/or the at least one outer tray. Further, the device may comprise a plurality of extendable legs to support the at least two trays, the at least two outer trays or the tray and the outer tray or any combination of trays and outer trays. The extendable leg allows the user to securely fix the tray on wet, muddy or uneven ground.

Further, the at least one extendable leg may comprise a leg attachment means which may be releasably attached to the tray or outer tray. This allows the user to dismantle the device and store it compactly when not in use.

Further, the leg attachment means may comprise a detachable body secured to the leg which may attach to the tray or outer tray via a leg attachment aperture through the base of the tray or outer tray.

Further, the leg attachment means may comprise a bolt which may attached to a threaded portion of the leg.

The leg may comprise a first body moveable relative to a second body, the leg may be moveable from a first position wherein the first body and the second body are unextended to a second position wherein the first body is extended relative to second body. These second body may be telescopically mounted within the first body.

The at least one extendable leg may comprise an extending means. Further, the extending means may comprise a securing means which May comprise a screw clamp. Further still, the screw clamp may comprise a lever placed through an aperture in the screw clamp body for use in turning the clamp. Even further still, the screw clamp may comprise a threaded portion insertable into the first body to engage with and secure the second body. This provides an advantage that it allows the user to easily secure the at least one extending leg in place when it is in the second extended position.

The first body further may comprise a first portion and a second portion, the first portion may have a diameter and the second portion may have a larger diameter. Further, the second portion may comprise an aperture for use with the securing means. Further still, the aperture may be threaded for use with the threaded portion of the screw clamp.

Further, the first portion may comprise a pointed end for insertion into the ground. Further still, the pointed end of the first portion may be at an opposite end to the second portion. This provides an advantage that it allows the user to easily insert the at least one extending leg into the ground to provide added security on saturated or muddy ground.

The leg may be extendable by between 2.5 cm and 25 cm, preferably between 7.5 and 17.5 cm. This provides an advantage that it allows the user to easily insert the leg deep into the ground to provide added security on saturated or muddy ground.

The first body may comprise a receiving bore extending from the upper surface of the first portion partway through the first body for receiving the second body.

The second body may comprise a first portion and a second portion. Further, the first portion of the second body may have a diameter and the second portion may have a smaller diameter for use with the receiving bore of the first body. Further still, the first portion of the second body may comprise an abutment surface which may abut the upper surface of the first portion when in the first unextended position.

Further, the second portion of the second body may comprise a gripping means. Further still, the gripping means may comprise a protrusion. This provides an advantage that it allows the user to easily manipulate the at least one extending leg.

Further, the first portion of the second body may comprise a bore for receiving the leg attachment means. Further still, the bore may comprise the threaded portion for receiving the bolt of the leg attachment means. This provides an advantage that it allows the user to easily insert the bolt into the at least one extending leg.

The device may comprise at least one heat shield. Further, the heat shield may comprise a flat surface that may have a length which is substantially the same length as the at least one tray or at least one outer tray. The heat shield provides an advantage that it provides heat protection and/or regulation across the entire width of the at least one tray or at least one outer tray. In particular, the container may be made from a plastics material, and cooking equipment such as stove may be mounted on the tray in use. The heat shield therefore prevents damage to the container when the device is being used for cooking. The heat shield may be made from metal, or from a material with a low thermal conductivity such as a ceramics material.

The heat shield may comprise a lip substantially perpendicular to the flat surface.

The heat shield may be releasably attachable to the tray via at least one heat shield attachment means. Further still, the at least one heat shield attachment means may comprise at least one magnet. This provides an advantage that it allows the user to easily attach and release the at least one heat shield to the at least one tray or at least one outer tray.

The heat shield may be 0.1 to 5 mm thick, preferably 1 to 3 mm, more preferably 2 mm. This gives the advantage of allowing the user to reflect a substantial amount of heat from one side.

Further, the heat shield may form a first tray portion and a second tray portion either side of the heat shield when the heat shield is releasably attached to the tray. This gives the advantage that when in use with the tray the first and second tray portions forms a heating portion and a warm portion either side of the heat shield, allowing the user to protect a side wall of the container from heat damage and potential deformation and also allows cooked food to be kept warm in the warm portion when cooked as opposed to being left exposed to an unheated environment thus improving quality.

The lid may comprise a raised lip on its edge. Further, the lid may comprise a receiving portion for receiving a food preparation board, which may comprise a chopping board. Further still, the receiving portion may comprise a protrusion on a proximal side of the lid. Further still, the receiving portion may comprise a protrusion extending around the circumference of the lid, creating a raised wall. Even further still, the protrusion may extend for between 1 and 10 mm, preferably between 2 and 8 mm. Even further still, the protrusion may be a distance from the lip of the lid. Even further still, the receiving portion may comprise at least one strengthening rib, preferably comprising a plurality of strengthening ribs. Even further still, the at least one strengthening rib may be between the protrusion and the lip. This provides an advantage that it allows the user to prepare food via an insertable chopping board while using the cooking equipment that will not slide off the lid and potentially contaminate the food or environment.

The tray may comprise a hose aperture in the tray surface for use with a hose, such as a hose connecting a gas stove to a gas bottle, which may be in a region of the tray distal from the attachment means. Further, the hose aperture may be in the heating portion of the tray.

The leg attachment aperture may be in a region of the tray distal from the attachment means. Further, the leg attachment aperture may be in the heating portion of the tray. Further, the leg attachment aperture may be on a central axis of the tray.

The device may comprise hanging means for hanging utensils which may comprise hooks. Further, the hanging means may be releasably attachable to an interior of the side walls of the container body via a hanging attachment means. This provides an advantage that it allows the user to hang used utensils in the interior of the container body and not allow them to drip onto the ground and contaminate the environment.

The device may comprise a cooking device which may comprise a gas stove. Further, the cooking device may comprise a base or legs, Further still, the base or legs may comprise optionally at least one attachment means, preferably comprising at least one magnet. Further, the cooking device may comprise at least one leg, preferably comprising a plurality of legs. Further still, the attachment means may be on the end of the base or legs distal to a main heat emitting region for attachment to the tray or outer tray. This gives the advantage of allowing the user to securely and releasably attach a cooking device to a surface and prevent the cooking device from being knocked over in use, or creating a hazard.

The device may comprise at least one attachment which may be insertable into the tray. Further, the at least one attachment may comprise a drying rack. Further, the at least one attachment may engage with the raised walls of the tray. This provides an advantage that it allows the user to wash any cooking equipment, plates, cutlery or utensils in the container body and then dry them on the at least one tray or at least one outer tray without contaminating them by leaving them on he ground or having the pack them away while wet.

The tray may comprise a ferrous metal. The at least one extendable leg may comprise a ferrous metal. The at least one outer tray may comprise a ferrous metal. This provides an advantage that it allows the user to use magnets to easily attach and release various components.

The tray may comprise a powder coating. At least a portion of the at least one extendable leg may comprise a powder coating. The at least one outer tray may comprise a powder coating metal. This provides an advantage that it allows the user to use the components in wet environments without concern about rust damage.

The device may comprise further items of cooking equipment including at least one of a saucepan, a frying pan, a kettle, a toaster, a mug, a plate, a bowl, cutlery, cooking utensils including a ladle, a slotted spoon, a spatula, a cleaning cloth.

According to a further aspect of the invention there may be provided a device for transporting and using cooking equipment comprising:
(i) at least one tray for use with a container;
and wherein
(ii) the device comprises a heat shield.

The heat shield may comprise a flat surface which may have a length which is substantially the same length as the at least one tray. This provides an advantage that it provides heat protection and/or regulation across the entire width of the at least one tray or at least one outer tray.

The heat shield may comprise a lip substantially perpendicular to the flat surface.

The heat shield may be releasably attachable to the at least one tray via at least one heat shield attachment means. Further, the at least one heat shield attachment means may comprise at least one magnet.

The heat shield may be 0.1 to 5 mm thick, preferably 1 to 3 mm, more preferably 2 mm. This gives the advantage of allowing the user to reflect a substantial amount of heat from one side.

Further, the heat shield may form a first tray portion and a second tray portion either side of the heat shield when the heat shield is releasably attached to the tray. This gives the advantage that when in use with the tray the first and second tray portions forms a heating portion and a warm portion either side of the heat shield, allowing the user to protect a side wall of the container from heat damage and potential deformation and also allows cooked food to be kept warm in the warm portion when cooked as opposed to being left exposed to an unheated environment thus improving quality.

The at least one tray may comprise at least one raised wall. Further, the tray may comprise at least one aperture on the at least one raised wall. Further still, the aperture may be a key hole. This allows the user to keep cooking and food preparation equipment safely on the tray while in use, prevent environmental contamination and provides a drip-tray for any cooking equipment.

The at least one tray may comprise a base which may comprise at least one aperture, preferably comprising a plurality of apertures.

According to a further aspect of the invention there may be provided a device for transporting and using cooking equipment comprising:
(i) at least one tray with at least one raised wall for use with a container;
and wherein
(ii) the device comprises at least one outer tray comprising at least one raised side walls; and
(iii) which is releasably attachable to the tray or trays via at least one attachment means.

This allows the user to use an increased amount of secure, steady workspace and potentially use a wider range of cooking equipment simultaneously.

The at least one tray may comprise a plurality of side walls, preferably comprising a plurality of side walls, more preferably comprising raised walls on every periphery of a base surface of the at least one tray. This allows the user to keep cooking and food preparation equipment safely on the at least one tray while in use, prevent environmental contamination and provides a drip-tray for the cooking equipment.

The at least one outer tray may comprise a plurality of side walls, preferably comprising a plurality of side walls, more preferably comprising raised walls surrounding the periphery of a base surface of the outer tray. This allows the user to keep cooking and food preparation equipment safely on the tray while in use, prevent environmental contamination and provides a drip-tray for any cooking equipment.

Further, the at least one outer tray may attach to the raised side wall of the tray.

The at least one attachment means may comprise a magnet. This provides an advantage that it allows the user to easily attach and release the at least one outer tray to the at least one tray.

The at least one outer tray attachment means may comprise a peg which may engage with an at least one outer tray attachment aperture on the at least one tray, preferably comprising a keyhole aperture, this provides the user with a secure means to lock the at least one tray in place and use the device with confidence.

The at least one outer tray attachment means may comprise a nut and bolt which may engage with the at least one outer tray attachment aperture on the at least one tray, preferably comprising a keyhole aperture, this provides the user with a secure means to lock the at least one tray in place and use the device with confidence.

The device may comprise a plurality of attachment means. The device may comprise a plurality of trays. The device may comprise a plurality of outer trays. This provides an advantage that it allows the user to use an increased amount of secure, steady workspace and potentially use a wider range of cooking equipment simultaneously.

According to a further aspect of the invention there may be provided a device for transporting and using cooking equipment comprising:
(i) a cooking device; and
(ii) a base or legs;
and wherein
(ii) the base or legs comprise at least one attachment means.

This gives the advantage of allowing the user to securely and releasably attach a cooking device to a surface and prevent spillages or damages to the equipment, user or environment. The at least one attachment means may comprise a magnet, making it very easy for the user to quickly attach and release the cooking device. Further, the attachment means may be on the end of the base or legs distal to a main heat emitting region for attachment to the tray or outer tray.

The cooking device may comprise a gas stove.

According to a further aspect of the invention there may be provided a kit of parts for transporting and using cooking equipment comprising a combination of:
(i) a container body comprising a base and side walls;
(ii) defining a receiving portion for storing cooking and food preparation equipment; and
(iii) at least one tray for supporting cooking equipment releasably attachable to a side wall of the container via an at least one attachment means; and
(iv) at least one extendable leg releasably attachable to the tray.

This is advantageous in that the user is thus able to securely and releasably attach a tray to the side of a portable container off the ground, preventing environmental damage and contamination, food contamination, and unclean or damaged cooking equipment. It is also advantageous in that it allows the user to easily transport the kit by hand.

The kit of parts may comprise a heat shield for use with the tray. The kit of parts may comprise at least one outer tray which may be releasably attachable to the tray.

The kit of parts may comprise at least one cooking device which may comprise a gas stove. Further, the gas stove may be releasably attachable to the tray via an attachment means, preferably the attachment means comprises a magnet.

It is to be appreciated that the embodiments of the invention described above have been given by way of example only and that modifications or combinations of features of the device in its various embodiments may be affected. The invention also extends to the individual components mentioned above, taken singly or in any combination.

### BRIEF DESCRIPTION OF DRAWINGS

Embodiments of the invention will now be described solely by way of example and with reference to the accompanying drawings in which:

FIG. 1 shows an isometric view of the device according to the present invention; and

FIG. 2 shows a schematic view of a peg in a side wall of a container body; and

FIG. 3 shows a schematic view of a bolt & nut and washers disposed through an aperture in the side wall of a container body; and

FIG. 4 shows a schematic view of a partially smooth bolt & nut and washers disposed through an aperture in the side wall of the container body; and

FIG. 5 shows an isometric view an extendable leg releasably attachable to a tray via an attachment means; and

FIG. 6 shows a schematic view of the extendable leg, a leg extending means with a first and second body; and

FIG. 7 shows a schematic view of the second body of the extendable leg; and

FIG. 8 shows a schematic view of the first body of the extendable leg; and

FIG. 9 shows a schematic view of the extendable leg in a first position; and

FIG. 10 shows a schematic view of the extendable leg in a second position; and

FIG. 11 shows a schematic view of the extendable leg with an aperture; and

FIG. 12 shows a schematic view of the extendable leg with a securing means; and

FIG. 13 shows a schematic view of the extendable leg and the securing means with a lever; and

FIG. 14 shows an isometric view of the device according to the present invention and a heat shield attachable to the tray; and

FIG. 15 shows an isometric view of the heat shield and heat shield attachment means; and

FIG. 16 shows a top-down view of the tray with the heat shield releasably attached; and

FIG. 17 shows an isometric view of a lid with a receiving portion; and

FIG. 18 shows an isometric view of the tray with a releasably attachable outer tray; and

FIG. 19 shows an isometric view of the device according to the present invention and a gas stove attachable to attachment means on legs; and

FIG. 20 shows an isometric view of the device according to the present invention and a gas stove attachable to magnetic attachment means on the tray; and

FIG. 21 shows an isometric view of an aspect of the device according to the present invention and a heat shield attachable to a tray; and

FIG. 22 shows an isometric view of the heat shield and heat shield attachment means; and

FIG. 23 shows a top-down view of the tray with the heat shield releasably attached; and

FIG. 24 shows an isometric view of an aspect of the device according to the present invention and a tray with a releasably attachable outer tray; and

FIG. 25 shows an isometric view of an aspect of the device according to the present invention and a gas stove attachable to attachment means on legs; and

FIG. 26 shows an isometric view of an aspect of the device according to the present invention and a gas stove attachable to magnetic attachment means on a tray.

### DETAILED DESCRIPTION OF DRAWINGS

As used herein the word “transporting” refers to a user manually, by hand and with no mechanical aid moving the device from one location to another. This is understood to refer to a single user transporting a device.

As used herein the phrase “cooking equipment” refers to any equipment a user would employ to prepare, process or cook food by hand including but not limited to; a cooking device, a stove, a hob, a burner, utensils, cutlery, plates etc.

As used herein the word “tray” refers to a surface suitable for preparing, processing or cooking food with cooking equipment as defined above and that would be used in an outdoor environment and is suitable for transporting as defined above.

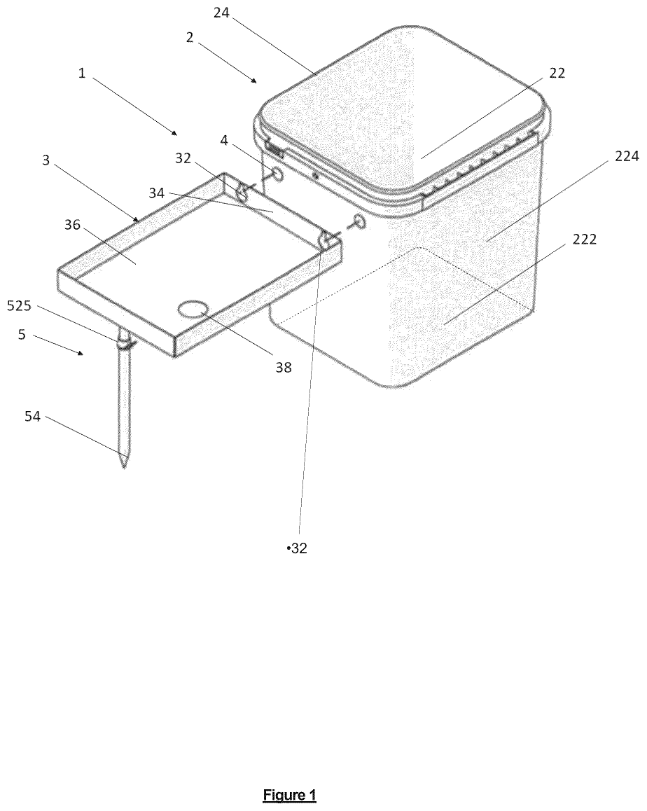

Referring to FIG. 1 there is shown a device according to the present invention generally indicated 1 for transporting and using cooking equipment comprising: a container body generally indicated 2 which comprises a receiving portion 22 for storing cooking and food preparation equipment which is defined by a base 222 and side walls 224. The container body 2 further comprises an upper edge 24 for receiving a lid (not shown).

The device 1 further comprises at least one tray generally indicated 3 for supporting cooking equipment, the tray comprising apertures 32 disposed on a side wall 34 upstanding from a tray surface 36, the apertures 32 shown in this configuration are keyhole apertures, with two being disposed on the raised side wall 34. The tray is releasably attachable to a side wall 224 of the container via at least one attachment means 4 disposed on a side wall 224 of the container body 2, and in FIG. 1 a configuration with two attachment means 4 on a side wall 224 is shown. A hose aperture 38 is also disposed in the surface 36 of the tray 3 through which a hose, such as a gas hose on a gas cooker, may extend in use. Further trays 3 may be attachable to other side walls 224 of the container body 2 via further attachment means 4.

The device further comprises an extendable leg generally indicated 5 comprising a leg extending means 52 and a pointed end 54 for insertion into the ground.

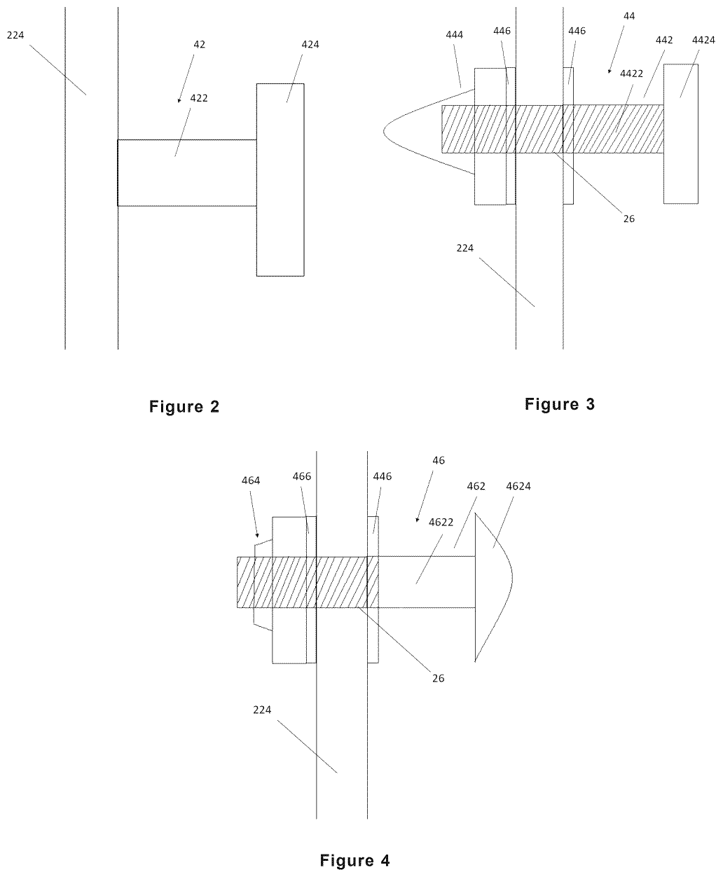

Referring to FIGS. 2 to 4 there are shown alternative embodiments of the attachment means 4. One embodiment, shown in FIG. 2 shows a peg 42 protruding from the side wall of the container body with a mounting body 422 of a first diameter, with a flange 424 at the distal end of the mounting body 422 for engagement with the aperture 32 on the raised side wall 34 of the tray 3. The peg 42 allows the tray 3 to be releasably mounted on the side wall 224 of the container body 2, especially when the keyhole configuration is used for the aperture 32, locking the tray 3 in place.

Referring to FIG. 3 there is shown an alternative embodiment of the attachment means 4 comprising a nut and bolt configuration 44 comprising a bolt 442 which fastens to a nut 444 either side of the side wall 224 of the container body 2, with washer 446 either side of the body. The bolt 442 extends through bolt aperture 26 in the side wall 224 of the container body 2. When assembled a mounting portion 4422 of the bolt will protrude from the outer surface of the side wall 224 of the container body 2, with the bolt head 4424 providing a flange, the mounting portion 4422 and bolt head 4424 allowing engagement with the aperture 32 on the raised side wall 34 of the tray 3. The nut and bolt configuration 44 allows the tray 3 to be releasably mounted on the side wall 224 of the container body, especially when the keyhole configuration is used for the aperture 32, locking the tray 3 in place.

Referring to FIG. 4 there is shown an alternative embodiment of the attachment means 4 comprising a partially smooth nut and bolt configuration 46 comprising a partially smooth bolt 462 which fastens to a nut 464 either side of the side wall 224 of the container body 2, with washer 466 either side of the body. The partially smooth bolt 462 extends through bolt aperture 26 in the side wall 224 of the container body 2. When assembled a smooth mounting portion 4622 of the bolt will protrude from the outer surface of the side wall 224 of the container body 2, with the bolt head 4624 providing a flange, the smooth mounting portion 4622 and bolt head 4624 allowing engagement with the aperture 32 on the raised side wall 34 of the tray 3. The partially smooth nut and bolt configuration 46 allows the tray 3 to be releasably mounted on the side wall 224 of the container body, especially when the keyhole configuration is used for the aperture 32, locking the tray 3 in place.

Referring to FIGS. 5 to 11 there is shown an embodiment of extendable leg 5. Referring first to FIG. 5 there is shown the extendable leg 5 comprising a first body 56 and the second body 58, the second body 58 being telescopically mounted in the first body 56. A screw 52 extends through the first body 56 which can be tightened to secure the relative positions of the first 56 and second body 58. The first body 56 comprising a pointed end for insertion into the ground.

Also shown is a leg attachment means 582 which releasably attaches the leg 5 to the tray 3. The leg attachment means 582 comprises a screw which extends through a leg attachment aperture 39 in the tray surface 36 and into a threaded aperture in the second body 58.

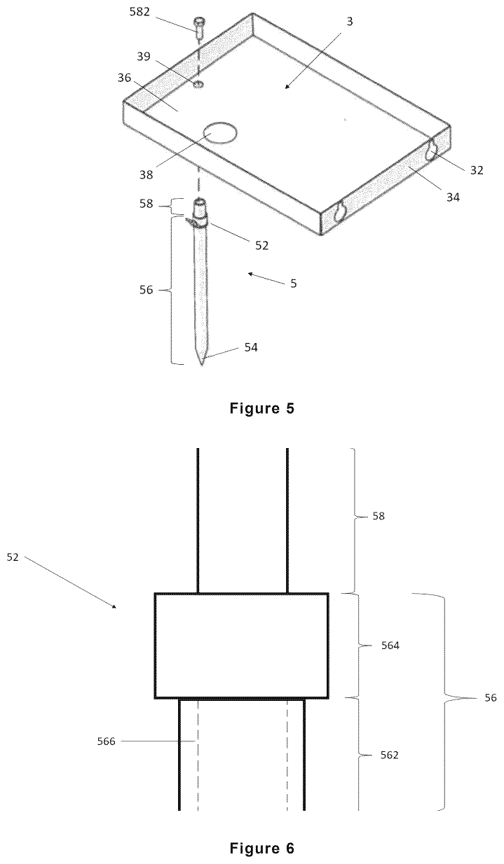

Referring to FIGS. 6 to 8 there is shown the leg extending means 52 and the components of the leg of which it is comprised, referring in particular to FIG. 6 there is shown a portion of the leg 5 comprising the first body 56, the second body 58, the first body comprising a first portion 562 and a second portion 564, the first portion having a diameter and the second portion having a larger diameter, the pointed end 54 being disposed at the end of the first body 56 opposite the second portion of the first body 564. Also shown in FIG. 6 is a bore hole 566 disposed centrally to the interior of the first body 58, the bore of a dimension to receive the second body 58.

Referring to FIG. 7 there is shown the second body 58 comprising a first portion 584 and a second portion 586, the first portion 584 having a diameter and the second portion 586 having a larger diameter. Also shown is the leg attachment means 582 which attaches to the second body 58 via a threaded receiving portion 588 formed by a threaded bore hole extending partway through the interior of the second portion 586. The extendable leg 5 is attachable to the container body 3 through an aperture 39 in the tray surface 36. Also shown is the second portion 589 of the second body 58 which comprises a gripping means 589 comprising a protrusion. Also shown is an abutment surface 5862 of the second portion 586 to abut the first body when the extendable leg 5 is in a first unextended position.

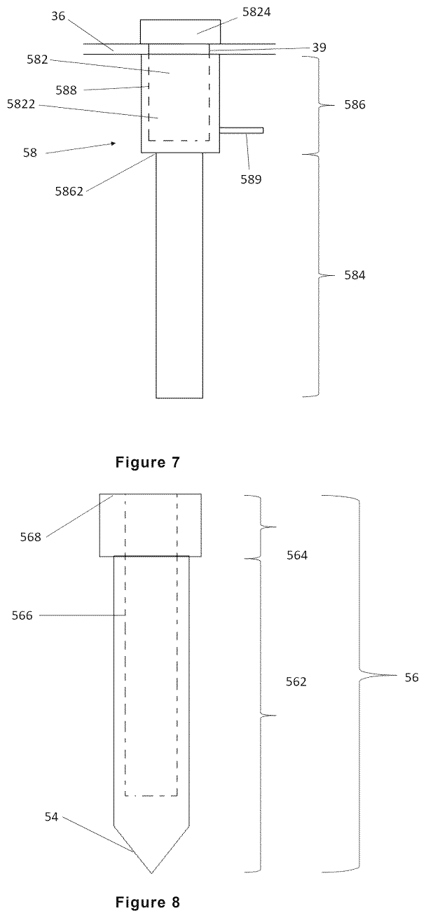

Referring to FIG. 8 there is shown the first body 56 comprising the first portion 563 and the second portion 564, with the pointed end 54 being at the end of the first body 56 opposite the second portion 564, the first body 56 comprising the bore hole 566 for receiving the first portion 584 or the second body 58. Also shown is a lower abutment surface 568 of the second portion 564 for engagement with the abutment surface 5862 of the second portion 586 of the second body 58 in the first unextended position.

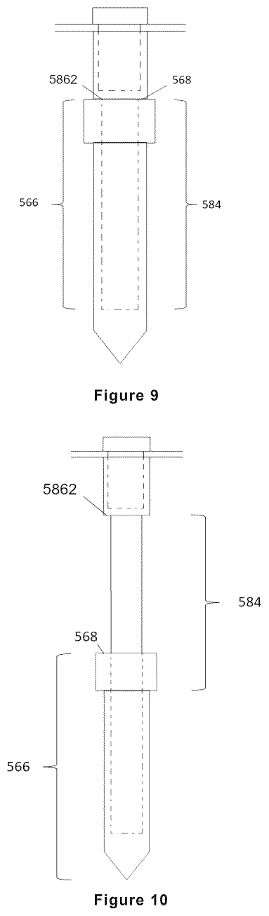

Referring to FIGS. 9 and 10 there is shown the extendable leg 5 in the first unextended position and a second extended position, the leg being moveable between the first and second positions via the leg extending means 52 as described above.

Referring to FIG. 9 there is shown the extendable leg 5 in the first unextended position wherein the first portion 584 of the second body 58 is contained within the bore hole 566 of the first body 56, with abutment surface 5862 of the second portion 586 of the second body 58 engaged with the lower abutment surface 568 of the second portion 564 of the first body 56.

Referring to FIG. 10 there is shown the extendable leg 5 in the second extended position wherein the first portion 584 of the second body 58 is only partially contained within the bore hole 566 of the first body 56 and most of the first portion 584 of the second body 58 being outside of the bore hole 56. The abutment surface 5862 of the second portion 586 of the second body 58 is not engaged with the lower abutment surface 568 of the second portion 564 of the first body 56.

The first portion 584 of the second body 58 is extendable by between 2.5 cm and 25 cm, preferably between 7.5 and 17.5 cm.

Referring to FIGS. 11 to 13 there is shown the securing means that allow the extendable leg 5 to be secured at a point between the first and second positions as described above using the leg extending means as described above.

Referring to FIG. 11 there is shown the extendable leg 5 in a first unextended position with the second body 58 inserted into the bore hole 566 of the first body 56. Also shown is a secured means aperture 5642 which is preferably threaded disposed on and through the second portion 564 of the first body 56.

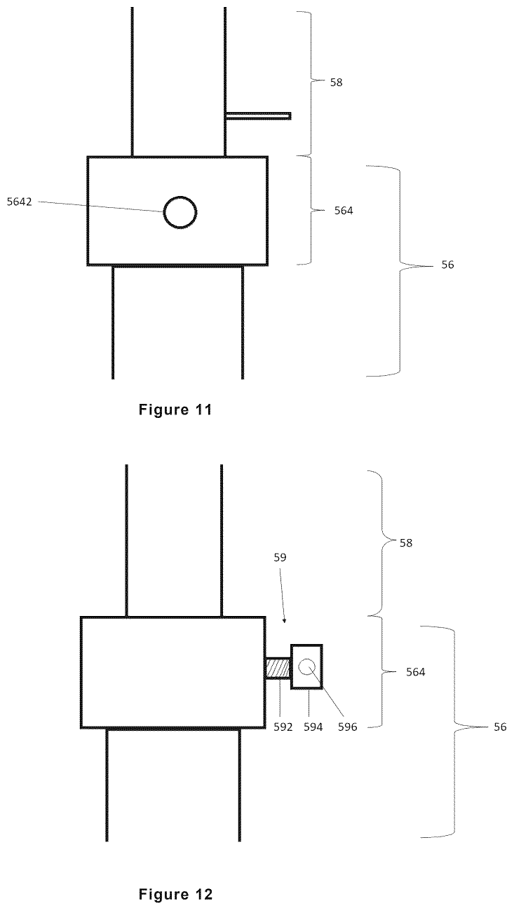

Referring to FIG. 12 there is shown the extendable leg 5 in a first unextended position with the second body 58 inserted into the bore hole 566 of the first body 56. Also shown is the securing means 59 comprising a first section 592 for engagement with the securing means aperture 5642 of the second portion 564 of the first body 56 which is preferably threaded. The securing means is insertable through the securing means aperture 5642 to engage with the first portion 584 of the second body 58 when it is either wholly or partially contained within the bore hole 566 of the first body 56, locking the second body in place anywhere between the first and second positions.

Also shown is a head 594 of the securing means 59 with a diameter larger than that of the first section 592 and comprising an aperture 596 extending through the head 594.

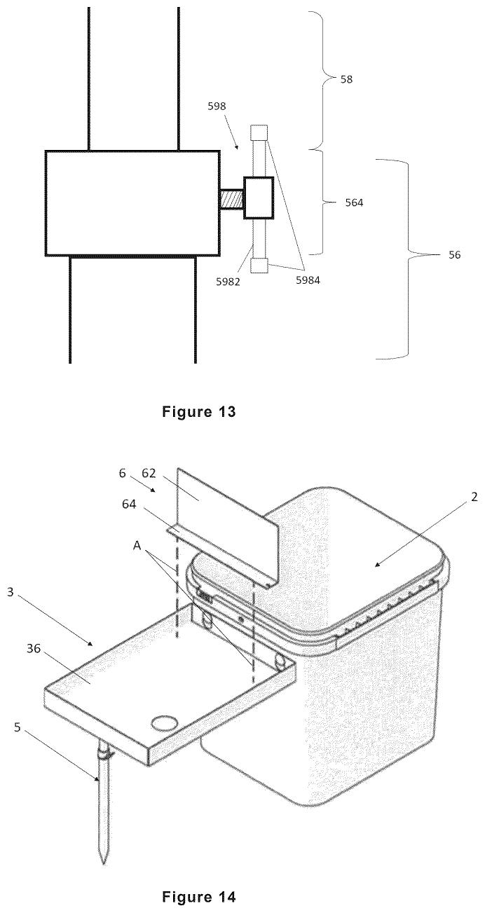

Referring to FIG. 13 there is shown the extendable leg 5 in a first unextended position with the second body 58 inserted into the bore hole 566 of the first body 56. The first section 592 of the securing means 59 is fully inserted through the securing means aperture 5642 of the second portion 564 of the first body 56 and engaged with the first portion 584 of the second body 58. Also shown is a securing means lever 598 comprising a first section 5982 with a diameter suitable for use with the aperture 592 extending through the head 594 of the securing means 59. The lever 598 further comprising detents 5984 on its distal ends with a diameter lager than both the first section 5982 and the securing means aperture 5642 of the second portion 564 of the first body 56. The lever allowing the user to easily releasably secure the extendable leg 5 in position.

Referring to FIGS. 14 to 16 there is shown device 1, wherein the tray 3 and extendable leg 5 are releasably attached to the container body 2, with the device comprising a heat shield 6 releasably attachable to the tray surface 36 of the tray 3. Referring to FIG. 14 there is shown the heat shield 6 comprising a flat surface 62 and a lip 64 which is perpendicular to the flat surface 62. The heat shield 6 releasably attaches to the tray surface 36 in the orientation shown by vectors A. The heat shield preferably extends the width of the tray surface 36.

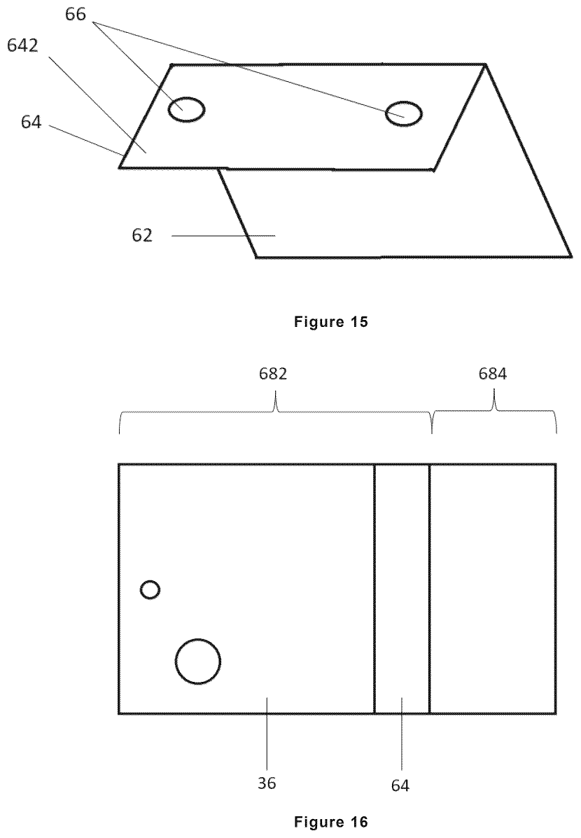

Referring to FIG. 15 there is shown the heat shield 6 comprising heat shield attachment means 66, disposed on a lower surface 642 of the lip 64 for releasably attaching the heat shield 6 to the tray surface 36.

Referring to FIG. 16 there is shown the heat shield 6 releasably attached to the tray surface 36 via the heat shield attachment means 66, preferably comprising magnets, on the lower surface 642 of the lip 64. When in use, the deployment of the heat shield 6 creates a first tray portion 682 and a second tray portion 684. The first tray portion 682 being the region created on the side of the heat shield 6 distal to the container body 2 and the second tray portion 684 being the region created on the side of the heat shield 6 proximal to the container body 2.

When in use with the first tray portion 682 and the second tray portion 684 form a heating portion and a warm portion respectively either side of the heat shield 6, allowing the user to protect a side wall of the container from heat damage and potential deformation and also allows cooked food to be kept warm in the warm portion when cooked while food is cooked in the heating portion.

The heat shield 6 may be 0.1 to 5 mm thick, preferably 1 to 3 mm, more preferably 2 mm. This allows the second tray portion 684 to keep food warm without heat damaging the side wall 222 of the container body 2 to which the tray 3 is attached when in use.

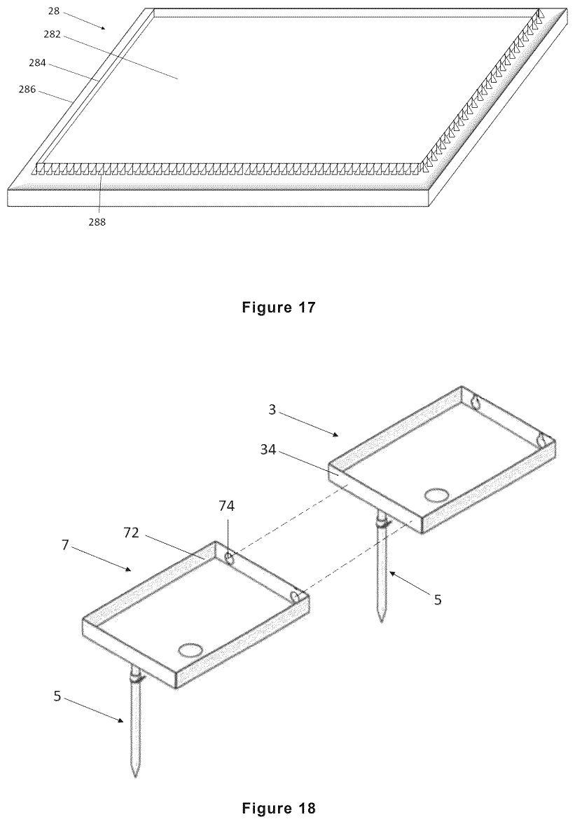

Referring to FIG. 17 there is shown a preferred embodiment of the device wherein a lid 28 for use with the upper edge 24 of the container body 2. The lid 28 comprises a receiving portion 282 for receiving a food preparation board (not shown). The receiving portion 282 comprises a protrusion 284 extending around the perimeter 286 of the lid 28, a distance from the permitter 286 of the lid 28, creating a raised wall. The protrusion may extend for between 1 and 10 mm, preferably between 2 and 8 mm. The receiving portion 282 comprises strengthening ribs 288 between the protrusion 284 and the perimeter 286.

Referring to FIG. 18 there is shown a preferred embodiment of the device wherein an additional tray 7 which is releasably attachable to the tray 3. The outer tray 7 comprises raised side walls 72 via an outer tray attachment means 74, preferably magnets, disposed on the raised side walls 72. The outer tray attachment means 74 releasably attach the outer tray 7 to the raised side wall 34 of the tray 3 distal to the container body 2 when in use. Alternative embodiments for the outer tray attachment means such as a peg or nut and bolt engaging with an aperture on the raised side wall 34 of the tray 3 are not shown.

Is it understood that FIG. 18 shows a single outer tray 7 releasably attaching to a single tray 3, but this is an exemplary embodiment as shown and the combination of an outer tray 7 releasably attaching to a tray 3 releasably attached to opposed side walls 224 of the container body 2, or an outer tray 7 releasably attaching to the raised side wall 72 of another outer tray 7 distal to the tray 3 are also within the scope of the various embodiments made possible by the various configurations of trays 3, outer trays 7 and outer tray attachment means 74 disclosed herein.

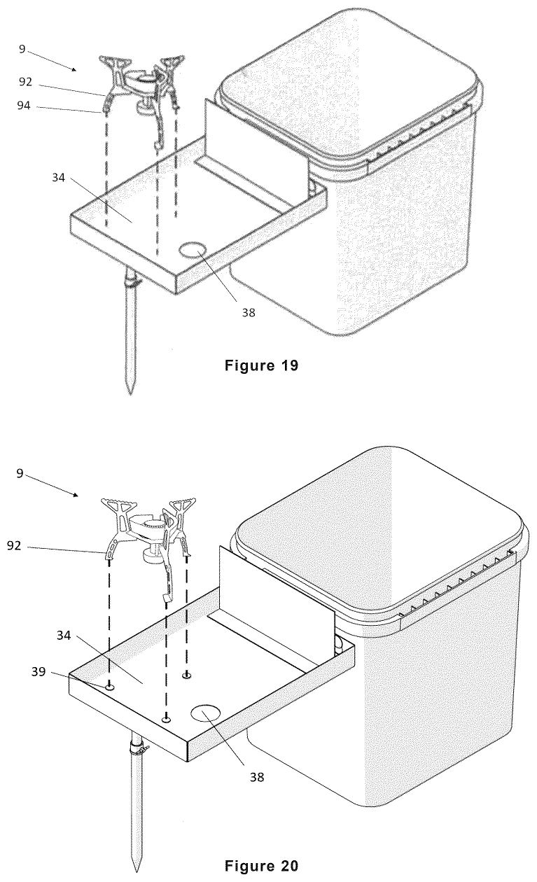

Referring to FIGS. 19 and 20 there is shown a preferred embodiment of the device wherein a cooking device 9, a gas stove is shown in a number of configurations for engagement with the tray 3.

Referring to FIG. 19 there is shown the cooking device 9 with legs 92 which each comprise an attachment means 94, comprising a magnet, for releasably attaching the cooking device 9 to the tray surface 34. A hose connected to a gas supply connects to the cooking device 9 through the hose aperture 38.

Referring to FIG. 20 there is shown a cooking device 9 with legs 92. The legs each releasably attach to an attachment means 39 on the tray surface 34, comprising a magnet. A hose connected to a gas supply connects to the cooking device 9 through the hose aperture 38.

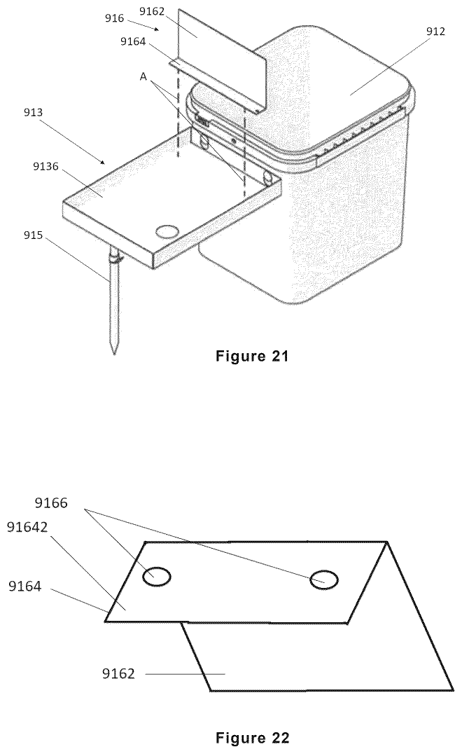

Referring to FIGS. 21 to 23 there is shown an alternative embodiment of the device 1 for transporting and cooking equipment comprising: a heat shield 916 releasably attachable to a tray surface 9136 of a tray 913. The tray 913 releasably attachable to a container body 912. Also shown is an extendable leg 915.

Referring to FIG. 21 there is shown the heat shield 916 comprising a flat surface 9162 and a lip 9164 which is perpendicular to the flat surface 9162. The heat shield 916 releasably attaches to the tray surface 9136 in the orientation shown by vectors A. The heat shield preferably extends the width of the tray surface 9136.

Referring to FIG. 22 there is shown the heat shield 916 comprising heat shield attachment means 9166, disposed on a lower surface 91642 of the lip 9164 for releasably attaching the heat shield 916 to the tray surface 9136.

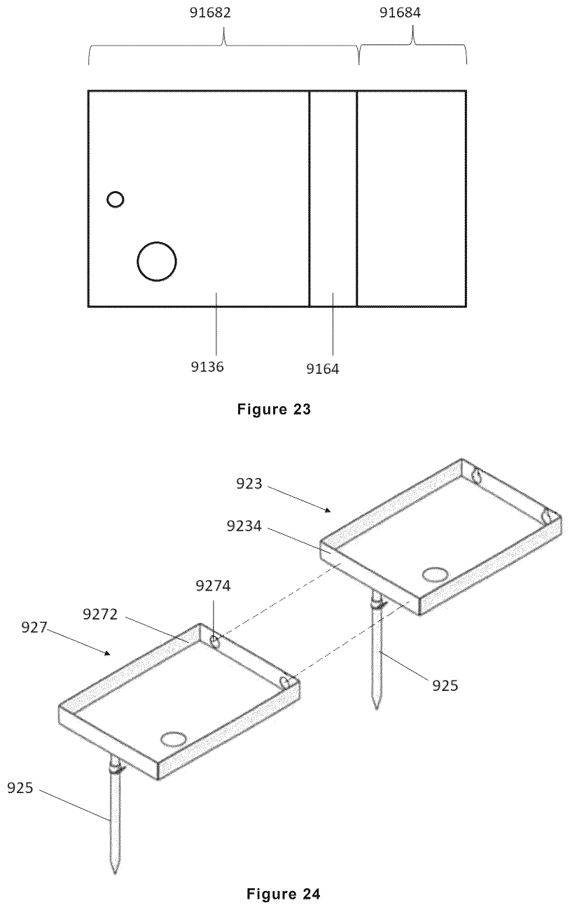

Referring to FIG. 23 there is shown the heat shield 916 releasably attached to the tray surface 9136 via the heat shield attachment means 9164, preferably comprising magnets, on the lower surface 91642 of the lip 9164. When in use, the deployment of the heat shield 916 creates a first tray portion 91682 and a second tray portion 91684. The first tray portion 91682 being the region created on the side of the heat shield 916 distal to the container body 912 and the second tray portion 91684 being the region created on the side of the heat shield 916 proximal to the container body 912.

When in use with the first tray portion 91682 and the second tray portion 91684 form a heating portion and a warm portion respectively either side of the heat shield 916, allowing the user to protect a side wall of the container from heat damage and potential deformation and also allows cooked food to be kept warm in the warm portion when cooked while food is cooked in the heating portion.

The heat shield 6 may be 0.1 to 5 mm thick, preferably 1 to 3 mm, more preferably 2 mm. This allows the second tray portion 684 to keep food warm without heat damaging the side wall 222 of the container body 2 to which the tray 3 is attached when in use.

Referring to FIG. 24 there is shown a is shown an alternative embodiment of the device 1 for transporting and cooking equipment comprising: a tray 923 and an additional tray 927 which is releasably attachable to the tray 923. The outer tray 927 comprises raised side walls 9272 via an outer tray attachment means 9274, preferably magnets, disposed on the raised side walls 9272. The outer tray attachment means 9274 releasably attach the outer tray 927 to a raised side wall 9234 of the tray 923 when in use. Alternative embodiments for the outer tray attachment means such as a peg or nut and bolt engaging with an aperture on the raised side wall 9234 of the tray 923 are not shown.

Is it understood that FIG. 24 shows a single outer tray 927 releasably attaching to a single tray 923, but this is an exemplary embodiment as shown and the combination of additional outer trays 927 releasably attaching to the raised side wall 9272 of another outer tray 927 distal to the tray 923 are also within the scope of the various embodiments made possible by the various configurations of trays 923, outer trays 927 and outer tray attachment means 9274 disclosed herein.

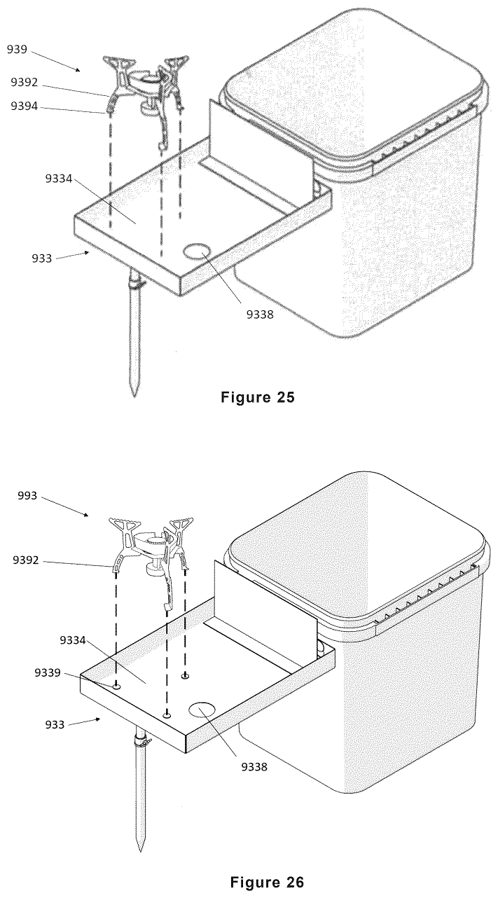

Referring to FIGS. 25 and 26 there is shown a is shown an alternative embodiment of the device 1 for transporting and cooking equipment comprising: a cooking device 939, a gas stove is shown in a number of configurations for engagement with a tray 933.

Referring to FIG. 25 there is shown the cooking device 939 with legs 9392 which each comprise an attachment means 9394, comprising a magnet, for releasably attaching the cooking device 939 to a tray surface 9334. A hose connected to a gas supply connects to the cooking device 939 through a hose aperture 9338.

Referring to FIG. 20 there is shown the cooking device 939 with legs 9392. The legs each releasably attach to an attachment means 9339 on the tray surface 9334, comprising a magnet. A hose connected to a gas supply connects to the cooking device 939 through the hose aperture 9338.

Referring to FIGS. 1 to 26 it is understood that there is provided a kit of parts for transporting and cooking equipment comprising any of the aforementioned embodiments, their components and features of a combination of features of separate embodiments.

It is to be appreciated that the embodiments of the invention described above with reference to the accompanying drawings have been given by way of example only and that modifications may be affected. Other constructions for the trays, heatshields, extendable legs, additional trays and various attachment means may be employed. Individual components shown in the drawings are not limited to use in their drawings and they may be used in other drawings and in all aspects of the invention. The invention also extends to the individual components mentioned and/or shown above, taken singly or in any combination.

1. A device for transporting and using cooking equipment comprising:
a container body comprising a base and side walls which defines a receiving portion for storing cooking equipment;
the device further comprises at least one tray for supporting cooking equipment, the tray being releasably attachable to a side wall of the container via an at least one attachment means; and wherein
the attachment means comprises a peg protruding from a side wall of the container body, the peg comprising a flange distal to the container body.

2. A device as claimed in claim 1, wherein the device comprises at least two trays, each tray being releasably attachable to attachment means disposed on the side walls of the container.

3. A device as claimed in claim 1, wherein the or each side wall comprises at least two attachment means for attachment of the at least one tray.

4. A device as claimed in claim 1, wherein the at least one tray comprises at least one raised wall, and is releasably attachable to the attachment means via at least one aperture in the at least one raised wall of the tray.

5. A device as claimed in claim 4, wherein the aperture is a keyhole aperture.

6. A device as claimed in claim 1, wherein the device further comprises at least one outer tray comprising at least one raised side wall and which is releasably attachable to the at least one tray via at least one outer tray attachment means.

7. A device as claimed in claim 6, wherein the at least one outer tray attachment means comprises a magnet.

8. A device as claimed in claim 6, wherein the device comprises a plurality of outer tray attachment means.

9. A device as claimed in claim 6, wherein the device comprises at least one extendable leg to support the at least one outer tray when connected to the at least one tray via the at least one outer tray attachment means.

10. A device as claimed in claim 6, wherein the device comprises at least one extendable leg to support the at least one tray when attached via the attachment means.

11. A device as claimed in claim 9, wherein the at least one extendable leg comprises a leg attachment means via which it is releasably attached to the tray.

12. A device as claimed in claim 9, wherein the at least one extendable leg comprises a leg extending means, which comprises a first body moveable relative to a second body.

13. A device as claimed in claim 12, wherein the first body comprises at least a first portion, comprising a pointed end for insertion into the ground.

14. A device as claimed in claim 1, wherein the device comprises at least one heat shield.

15. A device as claimed in claim 14, wherein the at least one heat shield comprises a lip substantially perpendicular to a flat surface of the heat shield.

16. A device as claimed in claim 14, wherein the at least one heat shield is releasably attachable to the tray via at least one heat shield attachment means.

17. A device as claimed in claim 16, wherein the at least one heat shield attachment means comprises at least one magnet.

18. A device as claimed in claim 14, wherein the at least one heat shield is 0.1 to 5 mm thick, preferably 1 to 3 mm, more preferably 2 mm.

19. A device as claimed in claim 16, wherein the at least one heat shield when releasably attached to the tray forms a first tray portion and a second tray portion either side of the heat shield.

20. A device as claimed in claim 1, wherein the device comprises a lid received on an upper edge of the side walls of the container body, the lid comprising a receiving portion for receiving a food preparation board.

21. A device as claimed in claim 20, wherein the receiving portion comprises a protrusion extending around the circumference of the lid, creating a raised wall defining the perimeter of the receiving portion.

22. A device as claimed in claim 1, wherein the device comprises a gas stove which comprises a base or legs.

23. A device as claimed in claim 22, where the base or legs comprise a magnet attached to the base of legs of the gas stove.

24. A kit of parts comprising a combination of:
a container body comprising a base and side walls, defining a receiving portion for storing cooking and food preparation equipment; and
at least one tray for supporting cooking equipment releasably attachable to a side wall of the container via an at least one attachment means; and
at least one extendable leg releasably attachable to the tray.
